(19) United States
(12) Patent Application Publication
(10) Pub. No.: US 2016/0253275 A1
(43) Pub. Date: Sep. 1, 2016

(54) INFORMATION PROCESSING DEVICE, INFORMATION PROCESSING SYSTEM, AND EXCLUSIVE CONTROL PROGRAM

(71) Applicant: FUJITSU LIMITED, Kawasaki-shi (JP)

(72) Inventor: Masato FUKUMORI, Chohu (JP)

(73) Assignee: FUJITSU LIMITED, Kawasaki-shi (JP)

(21) Appl. No.: 15/011,716

(22) Filed: Feb. 1, 2016

(30) Foreign Application Priority Data
Feb. 26, 2015 (JP) 2015-036735

(51) Int. Cl. G06F 13/16; G06F 13/364

(52) U.S. Cl. CPC G06F 13/16; G06F 13/364

(57) ABSTRACT

An information processing device has process execution units that execute respective processes; a lock variable storage device that stores, with respect to a lock relating to a common resource accessed by the process execution units, a lock variable having a lock state flag and a lock identification information which is updated when lock being acquired; and an exclusive control device that executes first lock acquisition processing, including, when the lock state flag is the lock release state, updating the lock state flag to the lock acquisition state, and updating the lock identification information to newly updated one, to acquire the lock, and second lock acquisition processing, including, when the lock state flag is the lock acquisition state, updating the lock identification information to newly updated lock identification information to acquire the lock, after a time-out time elapses while the lock variable maintains the same lock identification information.

### CROSS-REFERENCE TO RELATED APPLICATION

This application is based upon and claims the benefit of priority of the prior Japanese Patent Application No. 2015-036735, filed on Feb. 26, 2015, the entire contents of which are incorporated herein by reference.

### FIELD

The present invention relates to an information processing device, an information processing system, and an exclusive control program.

### BACKGROUND

In an information processing system, one or a plurality of CPUs, one or a plurality of CPU cores, and one or a plurality of information processing devices execute in parallel a plurality of processes (or threads or jobs; represented hereinbelow as “processes”). Those CPUs, CPU cores, and information processing devices are process execution units that execute the program of the processes.

When process execution units access a common resource such as a common variable, the common resource is synchronized between the processes. The synchronization method is exclusive control such that when a certain process accesses a common resource, the access to the common resource by another process is prohibited. One example of such exclusive control uses an exclusive lock.

In exclusive control using a lock, a process which is to access the common resource acquires the lock in the state in which the lock is released, and only the process which has acquired the lock is allowed to access the common resource. Meanwhile, another process which has not acquired the lock is prohibited to access the common resource. Thus, it is possible to avoid a situation in which a plurality of processes simultaneously accesses the common resource and coherency with respect to the common resource is not able to be maintained between the processes.

In order to limit the acquisition of the lock to a single process, a lock variable is allocated to each common resource. Then, the process acquires the lock by rewriting the lock variable into a lock acquisition state and releases the lock by rewriting the lock variable into a lock release state. The process acquires the lock when the lock variable is in the lock release state, and waits for the lock release state when the lock variable is in the lock acquisition state.

The exclusive control using a lock is described in Japanese Laid-open Patent Publications No. H09-106357, H11-327934, H11-327931, and 2011-128975.

### SUMMARY

In the conventional exclusive control using a lock, the lock variable only stores the lock acquisition state and lock release state. Therefore, when the first process repeatedly acquires the lock, the second process is not able to distinguish whether the first process is not able to release the lock due to a hindrance, or the like, or the first process normally acquires the lock repeatedly. As a result, where the lock acquisition state has been detected repeatedly and timed out for a predetermined time, the second process sometimes erroneously releases the lock.

Further, where the first process acquires the lock, but is not able to release the lock thereafter due to a hindrance, or the like, a plurality of the second processes detect that the lock acquisition state has been detected repeatedly and timed out for a predetermined time and thereafter acquire the lock at the same time. For this reason, the exclusive control is not able to be appropriately performed.

An information processing device has

a plurality of process execution units that execute respective processes;

a lock variable storage device that stores, with respect to a lock relating to a common resource which is accessed by the plurality of process execution units, a lock variable having a lock state flag indicating a lock acquisition state and a lock release state, and a lock identification information which is updated each time the lock is acquired; and

an exclusive control device that executes

first lock acquisition processing, which includes, when the lock state flag is the lock release state, updating the lock state flag of the lock variable in the lock variable storage device to the lock acquisition state, and updating the lock identification information of the lock variable i to newly updated lock identification information, to acquire the lock for the process execution unit, and

second lock acquisition processing, which includes, when the lock state flag is the lock acquisition state, updating the lock identification information of the lock variable in the lock variable storage device to newly updated lock identification information to acquire the lock for the process execution unit, after a predetermined time-out time elapses while the lock variable in the lock variable storage device maintains the same lock identification information.

According to the first aspect, the exclusive control is appropriately performed between the processes by using a lock.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates the configuration of an information processing device 1 in which a plurality of processes (or process execution units) accesses a common resource.

FIG. 2 is a sequence diagram illustrating the exclusive control processing in the case of competition between the accesses to the common resource by the first and second processes in the information processing device depicted in FIG. 1.

FIG. 3 is a sequence diagram illustrating the exclusive control processing in the case in which the exclusive control device of the first process in the information processing device depicted in FIG. 1 appropriately repeats the lock acquisition and lock release.

FIG. 4 is a sequence diagram illustrating the exclusive control processing in the case in which the exclusive control devices of the second and third processes have detected the time-out of the lock state at substantially the same timing in the information processing device depicted in FIG. 1.

FIG. 5 depicts the configuration of the information processing device 1 in which a plurality of processes (or process execution units) in the present embodiment accesses a common resource.

FIG. 6 is a flowchart diagram of the lock acquisition processing in the exclusive control processing of the present embodiment.

FIG. 7 is a flowchart diagram of the processing of step S16 in FIG. 6.

FIG. 8 is a flowchart diagram of the processing of step S18 in FIG. 6.

FIG. 9 is a flowchart diagram of the CAS instruction illustrated by FIGS. 6 and 10.

FIG. 10 is a flowchart diagram of the lock release processing in the exclusive control processing of the present embodiment.

FIG. 11 is a sequence diagram of Example 1 in which the lock acquisitions of the first and second processes compete.

FIG. 12 is a sequence diagram of Example 2 in which the second process performs the lock acquisition after the lock acquisition by the first process.

FIG. 13 is a sequence diagram of Example 3 in which a time-out occurs and the second process performs lock acquisition during the lock acquisition by the first process.

FIG. 14 is a sequence diagram of Example 4 in which, when the first process repeats the lock acquisition and release, the second process is not able to detect the time-out in the same lock and the situation in which the two processes acquire together the lock is avoided.

FIG. 15 is a sequence diagram of Example 5 in which the second and third processes detect a time-out and the lock acquisitions compete during the lock acquisition by the first process.

FIG. 16 is a sequence diagram of the CAS instruction performed by the second process and the CAS instruction performed by the third process in FIG. 15.

FIG. 17 illustrates the configuration of an information processing device in the present embodiment.

FIG. 18 illustrates the configuration including two CPUs and disk storages depicted in FIG. 17.

FIG. 19 illustrates the configuration of the information processing system in the present embodiment.

### DESCRIPTION OF EMBODIMENTS

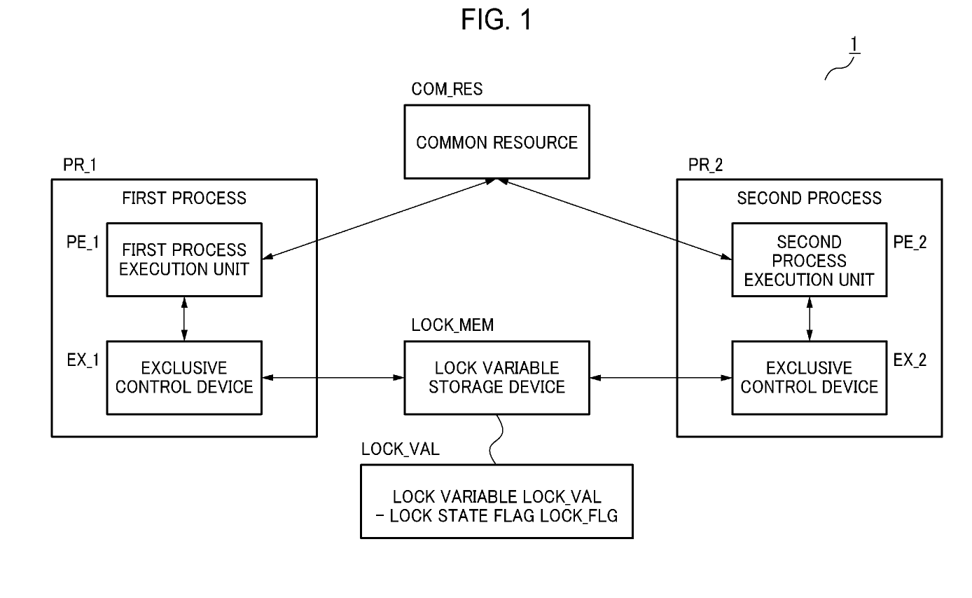

FIG. 1 illustrates the configuration of an information processing device 1 in which a plurality of processes (or process execution units) accesses a common resource. A first process PR_1 and a second process PR_2 access a common resource COM_RES. The plurality of processes is, for example, process units such as processors (CPU) or processor cores (CPU cores) in the information processing device 1, and the process of the process unit has processing of accessing the common resource. A plurality of process execution units is also, for example, processors (CPU) or processor cores (CPU cores) in the information processing device 1. The plurality of process execution units accesses the common resource by executing the processes. The plurality of process execution units also may be, for example, information processing devices such as computers, and in this case, the plurality of information processing devices accesses the common resource by executing the respective processes. In this case, the configuration 1 depicted in FIG. 1 is an information processing system.

The access to the common resource includes the processing of changing the state of the common resource or the processing of rewriting, for example, a common variable in a memory.

When a plurality of processes is executed in parallel, the information processing device 1 performs exclusive control between the processes. When the exclusive control is performed between the first and second processes, the information processing device 1 functions as a device having functional blocks depicted in FIG. 1.

A first process execution unit PE_1 executes the first access processing to the common resource COM_RES by the first process PR_1. A second process execution unit PE_2 executes the second access processing to the common resource COM_RES by the second process PR_2.

An exclusive control device EX_1 accesses a lock variable storage device LOCK_MEM to acquire a lock when the first process execution unit PE_1 executes the first access processing, and accesses a lock variable storage device LOCK_MEM to release the lock when the first access processing is ended. Likewise, an exclusive control device EX_2 accesses a lock variable storage device LOCK_MEM to acquire a lock when the second process execution unit PE_2 executes the second access processing, and accesses a lock variable storage device LOCK_MEM to release the lock when the second access processing is ended. Functions of the exclusive control devices EX_1 and EX_2 are realized, for example, as a result of the CPU or CPU core executing the exclusive control program which is one of API functions in an operation system (referred to hereinbelow as OS).

The common resource COM_RES is, for example, variables in a memory or tables in a database. Meanwhile, the lock variable storage device LOCK_MEM is realized in a memory accessed by the CPU or CPU core and stores each lock variable LOCK_VAL correspondingly to each common resource COM_RES. The lock variable LOCK_VAL has a lock state flag LOCK_FLG having a lock acquisition state and a lock release state with respect to the common resource.

In the example depicted in FIG. 1, the lock variable LOCK_VAL does not have lock identification information (lock ID) which is updated anew each time a lock is acquired, as in the below-described embodiment. Therefore, as indicated hereinbelow, the process is not able to perform the exclusive control appropriately between the processes in the time-out processing in which locks are forcibly acquired when the lock acquisition state is continuously timed out for a predetermined time. The process is also not able to appropriately perform the lock release processing.

As mentioned hereinabove, the process execution unit PE, which is a CPU or CPU core, acquires a lock, accesses the common resource, and releases the lock after the access end by executing the process PR. Further, when the process PR calls the exclusive control program of OS, the exclusive control device EX, such as the CPU or CPU core, which executes the exclusive control program executes the exclusive control of lock acquisition or release. Thus, the process PR, which is a processing unit, accesses the common resource as a result of being executed by the process execution unit PE which is a CPU or CPU core. A simplified expression of “the process accesses the common resource” may be also used hereinbelow. Likewise, the exclusive control program performs the exclusive control as a result of being executed by the exclusive control device EX which is a CPU or CPU core. A simplified expression of “the exclusive control device EX performs the exclusive control” may be also used hereinbelow.

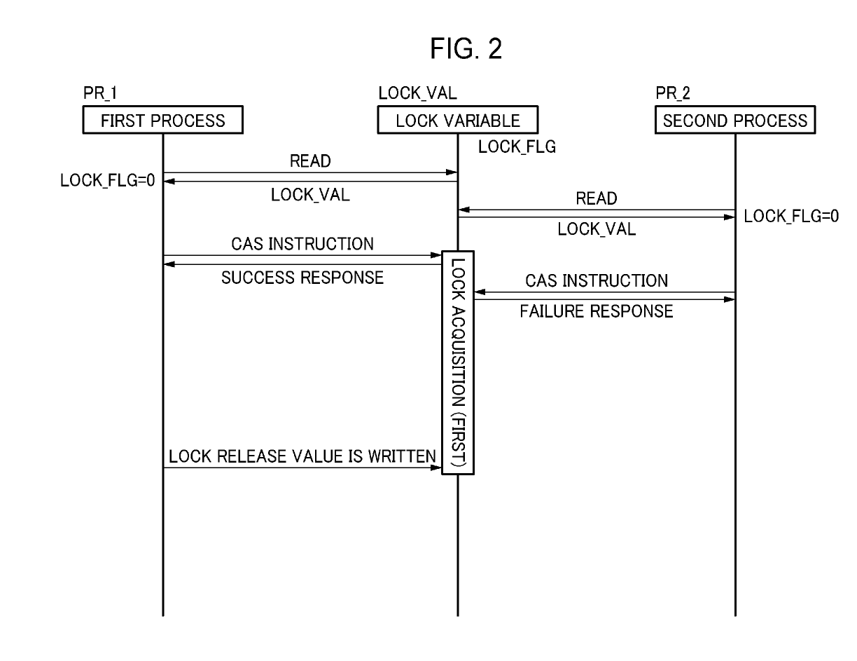

FIG. 2 is a sequence diagram illustrating the exclusive control processing in the case of competition between the accesses to the common resource by the first and second processes in the information processing device depicted in FIG. 1. It is assumed that in the initial state, none of the processes acquires a lock with respect to a common resource. Therefore, the lock state flag LOCK_FLG of the lock variable LOCK_VAL is a lock release state (LOCK_FLG=0).

When the access to the common resource is executed, the first and second processes PR_1, PR_2 cause the exclusive control device EX to execute the lock acquisition processing. More specifically, the first and second processes PR_1, PR_2 call the lock acquisition program of the exclusive control program which is the API function of the OS. The exclusive control device EX_1 executing the lock acquisition program called from the first process PR_1 reads (READ) the lock variable LOCK_VAL of the lock variable storage device LOC_MEM and detects that the lock state flag is the lock release state (LOCK_FLG=0). The exclusive control device EX_2 executing the lock acquisition program called from the second process PR_2 also reads (READ) the lock variable in the same manner and detects the lock release state.

In this case, the exclusive control device of the first process executes a compare-and-swap instruction (CAS instruction) in which the read-out lock variable is taken as an old value and the lock variable of the lock state flag (LOCK_FLG=1) of the lock acquisition state is taken as a new value, and swaps (changes) the lock variable LOCK_VAL to the new value. The CAS instruction is an atomic instruction that executes atomically the processing of comparing the old value with the lock variable in the lock variable storage device and the processing of rewriting the lock variable in the lock variable storage device into the new value only when the old value and the lock variable in the lock variable storage device match.

In the example depicted in FIG. 2, since the lock variable in the lock variable storage device and the lock variable which has been read immediately therebefore match in the same lock release state (LOCK_FLG=0), the CAS command of the exclusive control device of the first process ends successfully the processing of changing the lock acquisition state to the new value (lock acquisition state). As a result, the first process PR_1 acquires the lock with respect to the common resource.

Meanwhile, the exclusive control device of the second process executes the same CAS instruction after the CAS instruction of the exclusive control device of the first process. However, since the lock state flag LOCK_FLG of the lock variable LOCK_VAL at this time has already been changed to the lock acquisition state (LOCK_FLG=1), the CAS instruction ends as a failure. As a result, the first process PR_1 can exclusively perform the access processing to the common resource.

Where the first process PR_1 thereafter ends the access processing to the common resource, the first process calls the lock release program of the exclusive control program which is the API function of the OS. In this case, the exclusive control device which executes the lock release program called by the first process PR_1 writes the lock release value to change the lock state flag LOCK_FLG of the lock variable LOCK_VAL to the lock release state (LOCK_FLG=0).

When the exclusive control device, which executes the lock acquisition program called by the second process PR_2, detects the lock release state by reading the lock variable of the lock variable storage device after the lock variable has assumed the lock release state, the exclusive control device succeeds in the lock acquisition by executing the CAS instruction of taking the read-out lock variable as the old value and taking the lock variable of the lock acquisition state as the new value (this configuration is not depicted in FIG. 2).

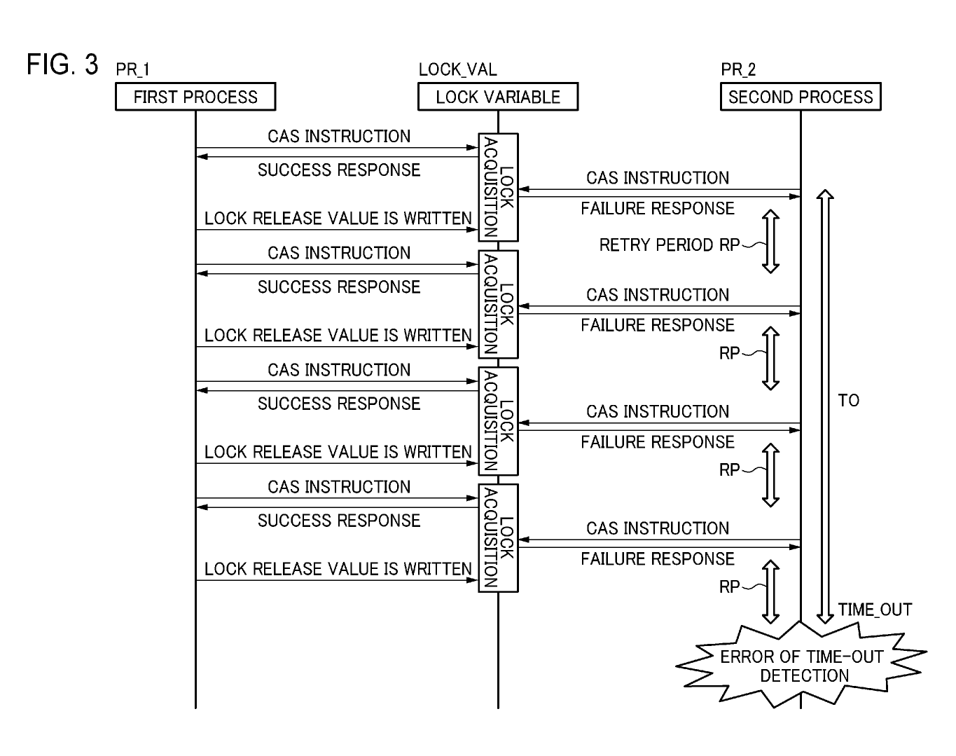

FIG. 3 is a sequence diagram illustrating the exclusive control processing in the case in which the exclusive control device of the first process in the information processing device depicted in FIG. 1 appropriately repeats the lock acquisition and lock release. In the exclusive control, it is desirable that time-out processing could be performed in which, where the lock state flag is the lock acquisition state when a certain process attempts to acquire a lock, a time-out is detected after a predetermined period of time elapses and the lock is forcibly acquired by the process. The time-out processing allows another process to acquire the lock when the process, which has acquired a lock, is not able to release the lock due to a hindrance, or the like.

In FIG. 3, the processing of reading the lock variable is omitted and the lock acquisition processing is only illustrated by the CAS instruction. In FIG. 3, it is assumed that each CAS instruction includes the processing of reading the lock variable.

In FIG. 3, the first process PR_1 appropriately repeats the lock acquisition and lock release. By contrast, the second process PR_2 repeatedly fails in the lock acquisition in each retry period RP. In this case, the exclusive control device executing the lock acquisition program which has been called by the second process PR_2 starts time-out determination after the initial lock acquisition failure, and when a time-out time TO has elapsed while the lock acquisition fails repeatedly, detects that the lock state is timed out. In response to this time-out detection, the exclusive control device of the second process PR_2 forcibly acquires the lock although the lock variable is in the lock acquisition state.

As a result, although the first process PR_1 appropriately performs the lock acquisition, the second process PR_2 forcibly acquires the lock and accesses the common resource. As a result, the first and second processes PR_1, PR_2 access the common resource at the same time and the exclusive control is not appropriately performed. In other words, the exclusive control device of the second process PR_2 erroneously detects the time-out of the lock state as a result of detecting the time-out after repeated lock acquisition failure on the basis of the lock acquisition state of the lock variable. The reason therefor is that the exclusive control device of the second process is not able to distinguish whether the exclusive control device of the first process repeats the lock acquisition appropriately or is not able to release the lock acquisition state due to an abnormality, or the like. In this case, the time-out processing involving forced lock acquisition is not performed appropriately.

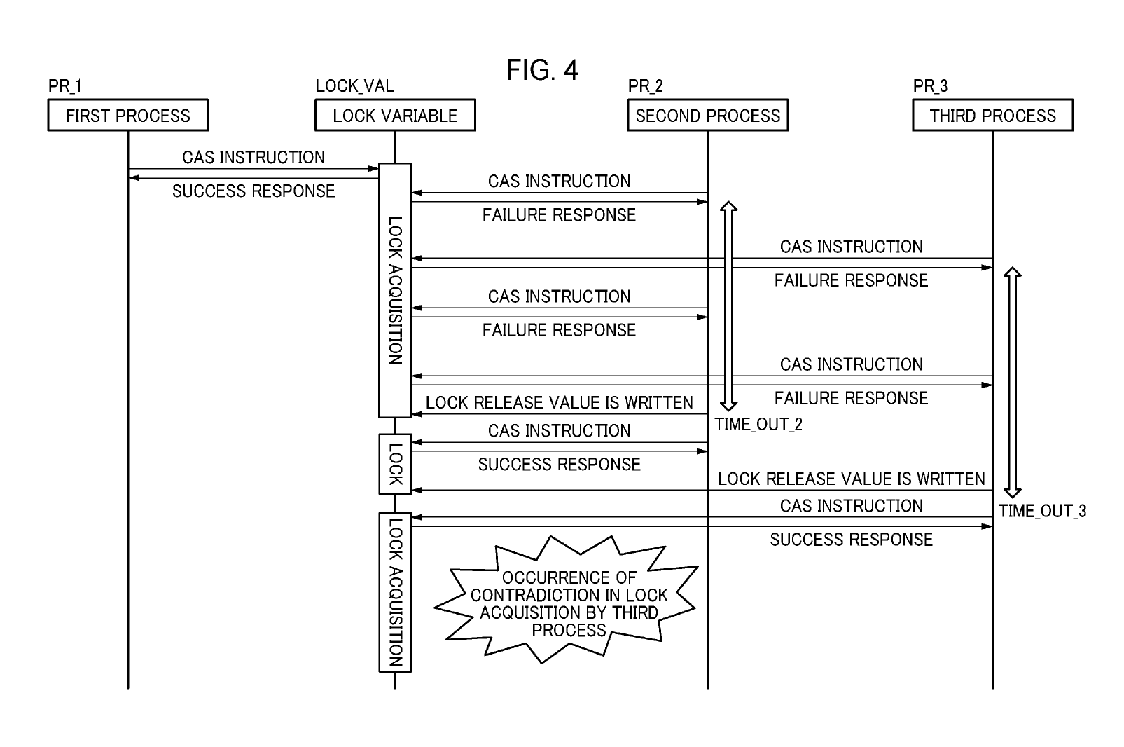

FIG. 4 is a sequence diagram illustrating the exclusive control processing in the case in which the exclusive control devices of the second and third processes have detected the time-out of the lock state at substantially the same timing in the information processing device depicted in FIG. 1. In FIG. 4, the processing of reading the lock variable is also omitted and the lock acquisition processing is only illustrated by the CAS instruction. In FIG. 4, it is also assumed that each CAS instruction includes the processing of reading the lock variable.

In FIG. 4, the exclusive control device of the first process PR_1 initially performs the lock acquisition. Then, the exclusive control device of the second process PR_2 repeatedly fails to acquire the lock, and detects a time-out after a predetermined time elapses (TIME_OUT_2). In response to this time-out detection, the exclusive control device of the second process changes the lock variable to the lock release state and then changes the lock variable to the lock acquisition state with the CAS instruction so as to acquire the lock,

Meanwhile, the exclusive control device of the third process PR_3 also repeatedly fails to perform the lock acquisition, and detects a time-out after a predetermined time elapses (TIME_OUT_3) In response to this time-out detection, the exclusive control device of the third process rewrites the lock acquisition state of the lock variable, which has been rewritten by the second process with the CAS instruction, into the lock release state, rewrites the lock variable with the CAS instruction, and acquires the lock.

In the case illustrated by FIG. 4, the first process PR_1 is not able to release the lock because hindrance has occurred, and the second and third processes together detect a time-out and acquire the lock. As a result, a situation can occur in which the second and third processes access the common resource and change the common resource at the same time. In this case, the exclusive control is not able to be performed appropriately,

In FIG. 3, where the exclusive control device of the first process repeats the lock acquisition and lock release, the exclusive control device of the second process erroneously detects the time-out of the lock state. Further, in FIG. 4, the exclusive control devices of the second and third processes together detect the time-out of the lock state. This is because, in either process, the lock variable has only the lock state flag and, therefore, different lock acquisition states are not able to be distinguished from each other.

### Present Embodiment

In the present embodiment, the lock variable has lock identification information in addition to the lock state flag indicating the lock acquisition state and lock release state. Further, when the lock is acquired, the exclusive control device updates the lock identification information of the lock variable in the lock variable storage device to new lock identification information. In other words, the lock identification information is updated each time the lock, is acquired. Therefore, the lock identification information distinguishes between the lock acquisition states produced by different lock acquisitions.

As a result, the exclusive control device appropriately detects the time-out of the lock state by determining that a time-out has occurred while the lock identification information is not changed. In order to check that the lock identification information has not changed, the exclusive control device stores new lock identification information, which has been updated when the lock was acquired, as an internal variable. Then, the exclusive control device determines, by the time-out determination processing of the lock state, whether the lock identification information at the time of lock acquisition and the lock identification information of the lock variable at the time of the determination match each other, and determines whether or not the lock acquisition state is maintained for a predetermined period of time, without the lock acquisition state being changed.

Where the lock identification information is used, as depicted in FIG. 3, when the exclusive control device of the first process repeats the lock acquisition and lock release, the exclusive control device of the second process detects that a different lock acquisition state has been assumed because the lock identification information has been changed and does not detect a time-out. Likewise, as depicted in FIG. 4, although the second and third processes start the time-out determination at the same time, the exclusive control device of the third process does not detect a time-out since the lock identification information has been updated by the second process.

[Configuration of Information Processing Device in the Present Embodiment]

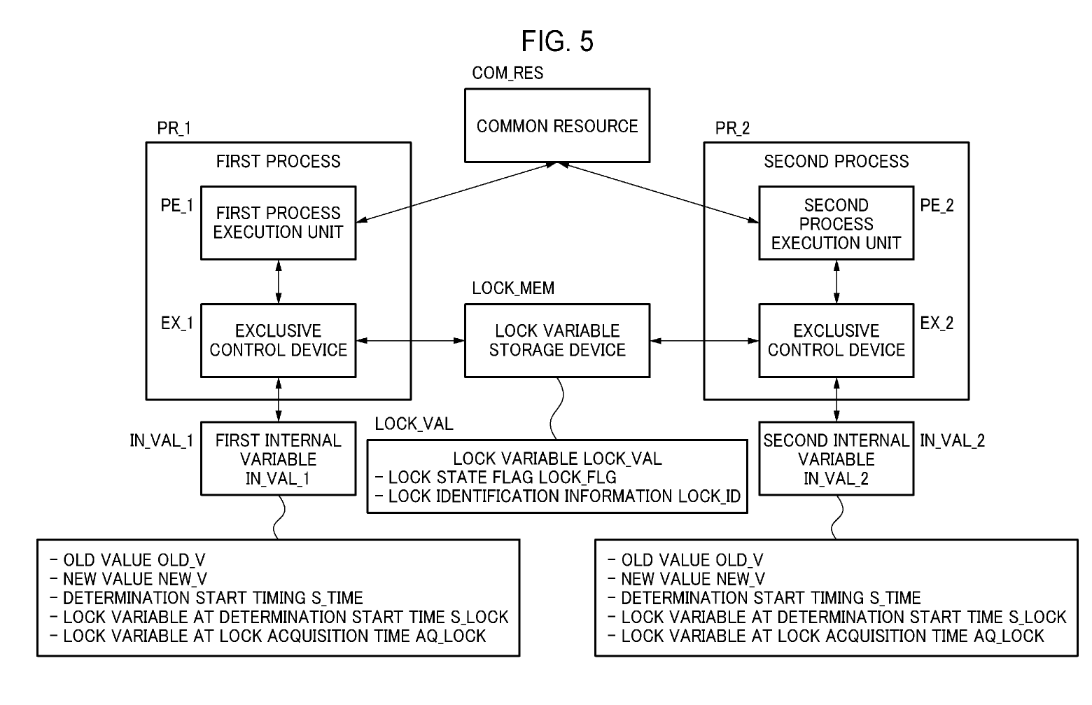

FIG. 5 depicts the configuration of the information processing device 1 in which a plurality of processes (or process execution units) in the present embodiment accesses a common resource. In FIG. 5, the first and second processes PR_1, PR_2, first and second process execution units PE_1, PE_2, respective exclusive control devices EX_1, EX_2, common resource CPM_RES, and lock variable storage device LOCK_MEM are the same as in FIG. 1.

The information processing device 1 depicted in FIG. 5 is different from that depicted in FIG. 1 in the aspects as follows. Firstly, the lock variable LOCK_VAL stored in the lock variable storage device LOCK_MEM has the lock identification information LOCK_ID, which is updated each time the lock is acquired, in addition to the lock state flag LOCK_FLG indicating the lock acquisition state and lock release state. Since the lock identification information LOCK_ID is updated each time the lock is acquired, this information is used to distinguish between the acquired locks. For example, different locks acquired by the same process can be distinguished by the lock identification information. Likewise, different locks acquired by different processes can be distinguished by the lock identification information.

For example, distinguishable information such as a time stamp and a numerical value that increases or decreases by a predetermined number at the time of updating is selected as the lock identification information LOCK_ID. In the below-described embodiment, a time stamp is used as the lock identification information.

Secondarily, the exclusive control devices EX_1, EX_2 execute the lock acquisition processing and lock release processing by using the respective internal variables IN_VAL_1, IN_VAL_2. The internal variables IN_VAL have an old value OLD_V and a new value NEW_V that are used for the CAS instruction, a time-out determination start timing S_TIME and a lock variable S_LOCK at the time of time-out determination start that are used for time-out determination, and a lock variable AQ_LOCK at the time of lock acquisition that is used for lock acquisition processing.

The time-out determination start timing S_TIME is the timing at which the exclusive control device initially detects the lock acquisition state and starts the time-out determination. The lock variable S_LOCK at the time of time-out determination start is a lock variable which is read when the time-out determination is started. The lock variable AQ_LOCK at the time of lock acquisition is a lock variable LOCK_VAL updated at the time of lock acquisition.

The lock variable S_LOCK at the time of time-out determination start may be only the lock identification information LOCK_ID among the lock variables LOCK_VAL. Likewise, the lock variable AQ_LOCK at the time of lock acquisition also may be only the lock identification information LOCK_ID.

Among those internal variables, the time-out determination start timing S_TIME is referred to as the determination start timing, and the lock variable S_LOCK at the time of time-out determination start is referred to as the lock variable at the time of determination start.

The first and second processes PR_1, PR_2 each include a critical instruction, that affects the execution of other processes, such as an access to the common resource and a write instruction to a common variable. For this reason, each process calls the lock acquisition processing program of the exclusive control program before the critical instruction affecting the execution of other processes. Then, the processes execute the critical instructions when the exclusive control device executing the lock acquisition processing performs the lock acquisition. Further, where the critical instruction ends, the processes call the lock release processing program of the exclusive control program and the exclusive control devices execute the lock release processing.

Therefore, the first and second processes PR_1, PR_2 have, for example, the following instruction sequences:

1. An instruction that calls the lock acquisition processing program.

2. A critical instruction.

3. An instruction that calls the lock release processing program,

[Summary of Lock Acquisition Processing]

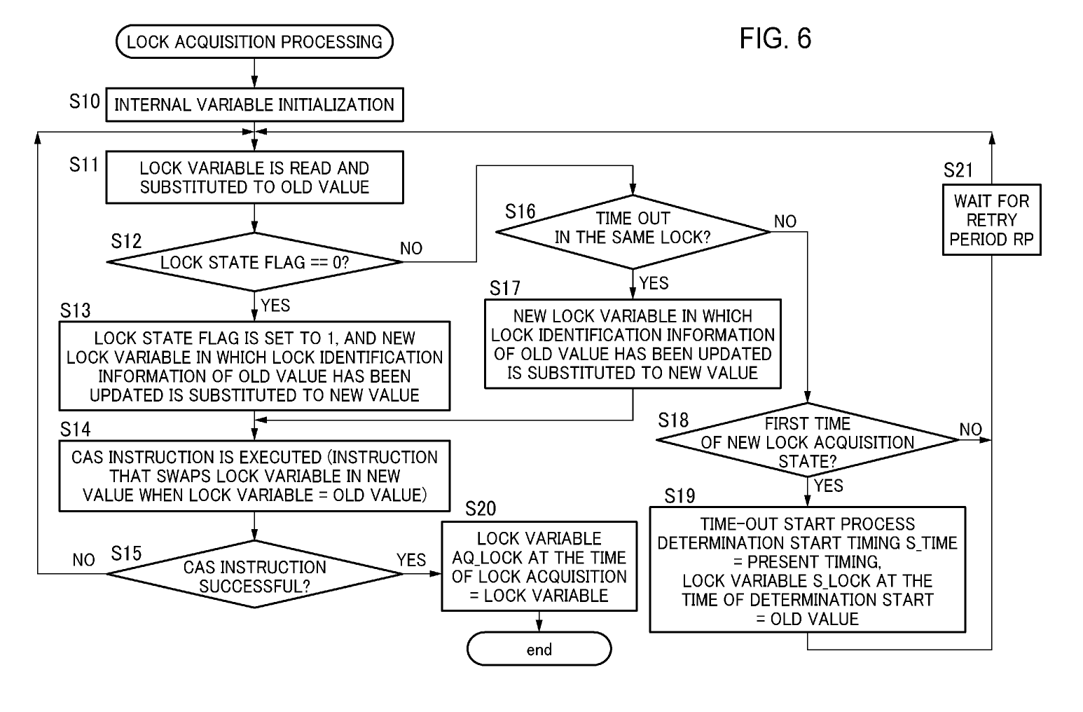

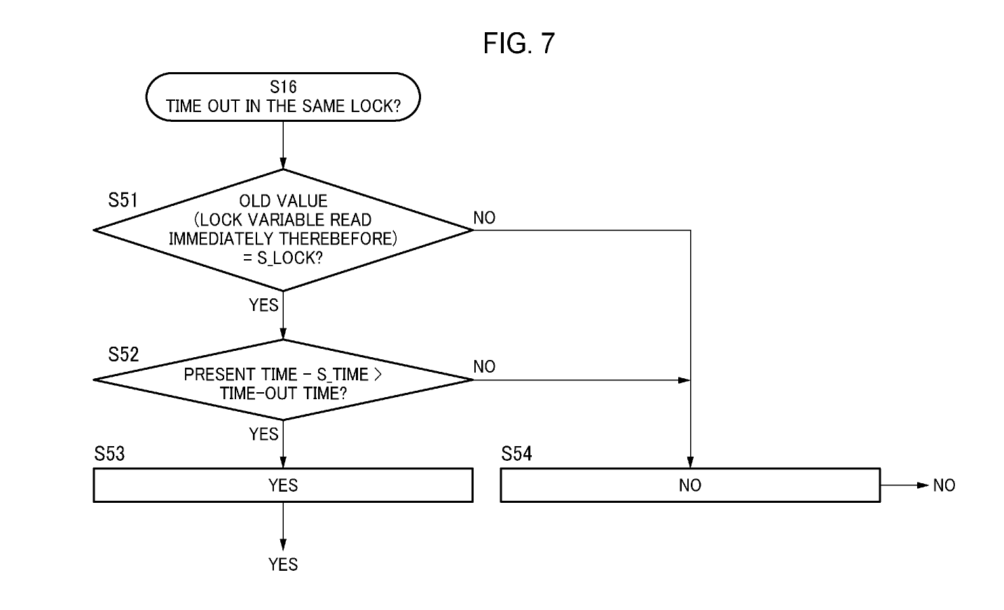

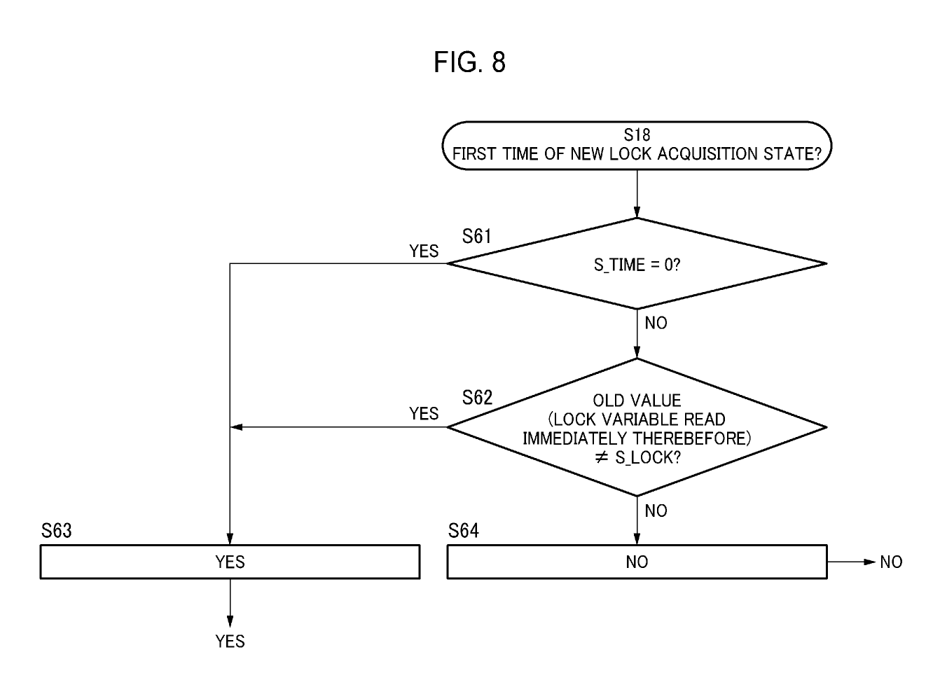

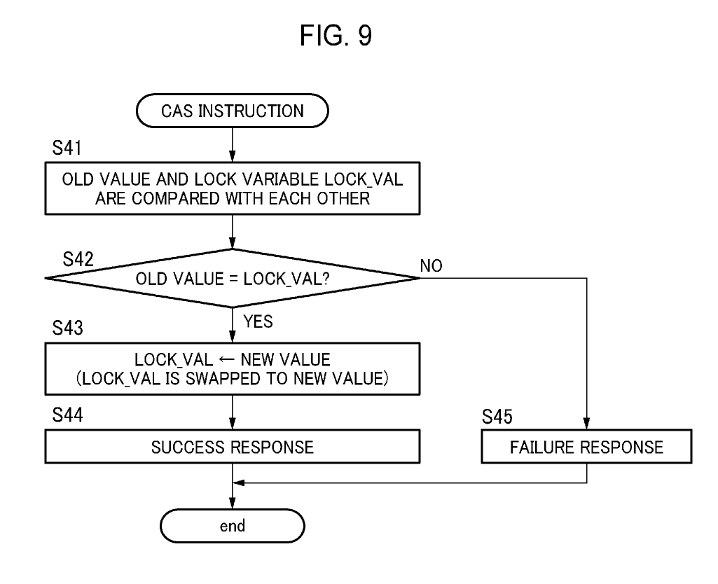

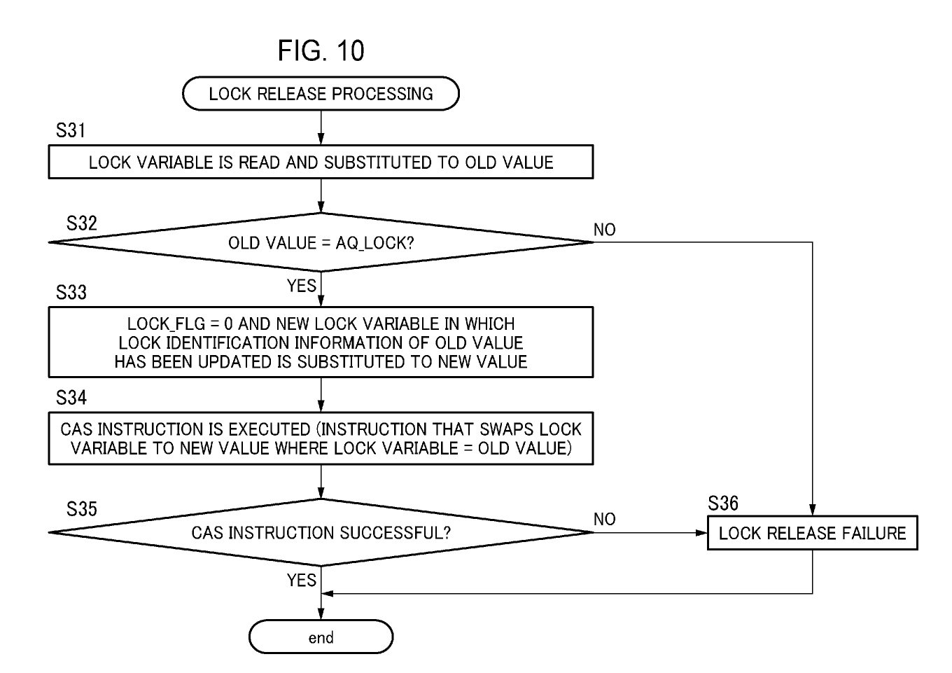

FIG. 6 is a flowchart diagram of the lock acquisition processing in the exclusive control processing of the present embodiment. FIG. 7 is a flowchart diagram of the processing of step S16 in FIG. 6. FIG. 8 is a flowchart diagram of the processing of step S18 in FIG. 6. FIG. 9 is a flowchart diagram of the CAS instruction illustrated by FIGS. 6 and 10. FIG. 10 is a flowchart diagram of the lock release processing in the exclusive control processing of the present embodiment. The summary of the lock acquisition processing and lock release processing is explained hereinbelow.

The flowchart of the lock acquisition processing depicted in FIG. 6 in general has the following seven processing flows.

Firstly, the first processing of acquiring the lock when the lock state flag LOCK_FLAG of the lock variable LOCK_VAL in the lock variable storage device LOCK_MEM is the lock release state (LOCK_FLG=0). The first processing has processing steps S10, S11, S12, S13, S14, S15, and S20.

Secondly, the second processing of starting the time-out determination when the lock state flag LOCK_FLG is the lock acquisition state (LOCK_FLG=1). The second processing has the processing steps S11, S12, S16, S18, S19, and S21.

Thirdly, the third processing of repeating the time-out determination in the lock acquisition state. The third processing has the processing steps S11, S12, S16, S18, and S21.

Fourthly, the fourth processing of confirming that the lock identification information LOCK_ID has changed in the time-out determination, canceling the preceding time-out determination, and starting the time-out determination anew. The fourth processing includes the processing steps S11, S12, S16: NO, S18: YES, S19, and S21.

Fifthly, the fifth processing of detecting a time-out and acquiring a lock in the lock acquisition state. The fifth processing has the processing steps S11, S12: NO, S16: YES, S17, S14, S15: YES, and S20.

Sixthly, the processing in which the lock acquisition is attempted in the lock release state, but the CAS instruction fails. The sixth processing has the processing steps of S11, S12: YES, S13, S14, and S15: NO.

Seventhly, the processing in which a time-out is detected in the lock acquisition processing, but the CAS instruction fails. The seventh processing has the processing steps of S11, S12: NO, S16: YES, S17, S14, and S15; NO.

When the lock acquisition processing depicted in FIG. 6 is started, the lock variable LOCK_VAL in the lock variable storage device is in the lock release state or has already assumed the lock acquisition state. In the case of the lock acquisition state, the lock identification information LOCK_ID becomes the time stamp at the time of lock acquisition.

The first to fifth processing are described hereinbelow with reference to FIG. 6.

[First Processing: S100]

In the processing of acquiring the lock in the lock release state, which is the first processing, initially, the exclusive control device EX initializes the internal variables (S10). In the initialization processing, initial values which are not able to be taken in the usual state are set for five internal variables. For example, the old value OLD_V and new value NEW_V are set to LOCK_FLG=0 and LOCK_ID=0, the determination start timing S_TIME is set to 0, the lock variable S_LOCK at the time of determination start and the lock variable AQ_LOCK at the time of lock acquisition are set to LOCK_FLG=0 and LOCK_ID=0.

Then, the exclusive control device EX reads the lock variable LOCK_VAL in the lock variable storage device LOCK_MEM and substitutes the read-out variable into the old value OLD_V (S11). As a result, the old value OLD_V becomes equal to the read-out lock variable LOCK_VAL. Then, the exclusive control device determines whether or not the lock state flag LOCK_FLG of the read-out lock variable is the lock release state (LOCK_FLG=0) (S12). In the first processing, the lock release state is realized (YES in S12), and therefore the exclusive control device substitutes a new lock variable, in which the lock state flag is 1 (LOCK_FLG=1) and the lock identification information LOCK_ID of the old value is updated to the new lock identification information, into the new value NEW_V (S13). In the example of the present embodiment, the lock identification information is a time stamp. Therefore, the new lock identification information is the present timing.

Then, the exclusive control device executes the CAS instruction, compares the old value with the current lock variable in the lock variable storage device and, where the two are equal, rewrites (swaps) the lock variable of the lock variable storage device to the new value (S14). The CAS instruction atomically processes the comparison and swapping. When the CAS instruction is success (S15: YES), the swapped lock variable is stored in AQ_LOCK.

FIG. 9 illustrates the processing of the CAS instruction. The CAS instruction has the processing steps S41, S42 for comparing the old value OLD_V and the lock variable LOCK_VAL and the processing (S43) of swapping the lock variable LOCK_VAL to the new value NEW_V (LOCK_FLG=1, LOCK_ID=present timing) when the old value and lock variable are equal to each other (YES in S42). Where the swap processing step S43 is performed successfully, a success response is returned (S44), and where the old value and lock variable are not equal to each other and the swap processing is not performed, a failure response is returned (S45).

As a result of performing the CAS instruction atomically, it is ensured that the lock variable does not change from the time the lock variable is read as an old value in step S11 to the time of CAS instruction execution and that the lock variable does not change during the CAS instruction.

[Second Processing: S200]

The processing of starting the time-out determination when the lock state flag LOCK_FLG is the lock acquisition state (LOCK_FLG=1), which is the second processing, has the processing steps S11, S12, S16, S18, S19, and S21. In the second processing, the initialization processing step S10 has already ended, and the processing is performed after the lock state flag has been updated to the lock acquisition state.

First, the exclusive control device EX reads the lock variable in the lock variable storage memory LOCK_MEM and substitutes the read-out variable into the old value OLD_V (S11). As a result, the old value OLD_V becomes equal to the read-out lock variable LOCK_VAL. Then, the exclusive control device determines whether or not the lock state flag LOCK_FLG of the read-out lock variable is the lock release state (LOCK_FLG=0) (S12). In the second processing, the lock acquisition state is realized (NO in S12), and therefore the exclusive control device determines whether or not the time-out has occurred in the same lock (S16). Since the time-out has not yet occurred in the second processing, the determination is NO. Then, the determination control device determines whether or not it is a first time of the new lock acquisition state (S18), and where it is the first time, the present timing is substituted to the determination start timing S_TIME, and the old value (LOCK_FLG=1, LOCK_ID=present ID) is substituted to the lock variable S_LOCK at the time of determination start, as the time-out determination start processing (S19). The determination control device then waits for the elapse of the retry time RP (S21).

FIG. 7 illustrates the time-out determination processing step S16. In the determination as to whether or not a time-out has occurred in the same lock, which is made in the processing step S16, it is determined as to whether or not the old value (lock variable which has been read immediately therebefore in the processing step S11) is equal to the lock variable S_LOCK at the time of determination start (YES in S51) and the elapsed time from the determination start timing S_TIME to the present timing is longer than the time-out elapse time (YES in S52). Where the two conditions are YES, it is determined that the time-out has occurred in the same lock, and the determination in the processing step S16 is YES (S53), where either of the conditions is NO, the determination in the processing step S16 is NO (S54).

The processing step S18 is depicted in FIG. 8. The determination as to whether or not it is the first time of the new lock acquisition state, which is made in the processing step S18, is YES (S63) when the determination start timing S_TIME=0 (YES in S61) or the old value (lock value which has been read immediately therebefore in the processing step S11) is not equal to the lock variable S_JOCK at the time of determination start (YES in S62). Where the two conditions are both NO, the determination is NO (S64).

In other words, where the lock state flag LOCK_FLG read in S11 is 1 immediately after the initialization of the internal variable in S10, since the determination start timing S_TIME, among the internal variables, is the initial value (S_TIME=0), YES is obtained in the processing step S61. Further, when the lock state flag LOCK_FLG read in S11 is 1 immediately after the initialization of the internal variable in S10, since the lock variable S_LOCK at the time of determination start, among the internal variables, is also the initial value and therefore S_LOCK is different from the old value, YES is also obtained in the processing step S62. Therefore, where YES is obtained in the processing step S61 or S62, it is determined that it is the first time of the new lock acquisition state.

After the lock acquisition state has been detected (NO in S12) after the initialization, and the elapse of the retry time RP after the time-out determination has been started has been waited for (S21), where the determination start timing S_TIME is other than the initial value (S_TIME≈0, NO in S61) and the old value (lock variable which has been read immediately therebefore in the processing step S11) is equal to the lock variable S_LOCK at the time of determination start (old value=S_LOCK, NO in S62), it is determined that it is the first time of the new lock acquisition state.

Further, where another lock is acquired anew after the lock acquisition state has been detected (NO in S12) after the initialization, and the elapse of the retry time RP after the time-out determination has been started has been waited for (S21), since at least the old value (lock variable which has been read immediately therebefore in the processing step S11) is not equal to the lock variable S_LOCK at the time of determination start (old value≈S_LOCK, YES in S62), it is determined that it is the first time of the new lock acquisition state.

In FIG. 8, the processing step S62 may be omitted, and where YES is obtained in the processing step S61, it may be determined that the new lock acquisition state is for the first time, and where NO is obtained, it may be determined that the new lock acquisition state is not for the first time

[Third Processing: S300]

The processing repeating the time-out determination in the lock acquisition state, which is the third processing, has the processing steps S11, S12, S16, S18, and S21. In the third processing, the processing step S16 of time-out determination yields NO because the time-out is in the same lock, but the time-out elapse time has not been reached. As a result, the processing steps S11, S12, S16, S18, and S21 are repeated.

[Fourth Processing: S400]

In the fourth processing, it is determined, in the lock acquisition state, that the lock identification information LOCK_ID has been changed in the time-out determination, the preceding time-out determination is canceled and new time-out determination is started. The fourth processing has processing steps S11, S12, S16: NO, S18: YES, S19, and S21.

The fourth processing is similar to the second processing in that the time-out determination is performed in the lock acquisition state, but by contrast with the second processing, in the processing step S16 of time-out determination, it is detected that the lock identification information LOCK_ID of the lock variable (the old value) is different from the lock identification information LOCK_ID of the lock variable at the time of determination start, and the determination result becomes NO. As a result, it is determined in the processing step S18 that the first time for the new lock is realized and YES is obtained, and the time-out start processing is performed in which the determination start timing S_TIME is substituted anew to the present timing and the lack variable S_LOCK at the time of determination start is substituted anew to the old value (S19). As a result, the third processing S300 is repeated again.

[Fifth Processing: S500]

The processing of detecting the time-out and acquiring the lock in the lock acquisition state, which is the fifth processing, has the processing steps S11, S12, S16: YES, S17, S14, S15: YES, and S20. In the fifth processing, since the time-out time has elapsed in the same lock as a result of repeating the third processing, the time-out determination processing step S16 yields YES. In this case, the exclusive control device substitutes the new lock identification information LOCK_ID, in which the lock identification information of the old value (lock variable which has been read in the processing step S11 immediately therebefore) to the new value (S17) and executes the CAS instruction (S14). The new lock identification information LOCK_ID is the time stamp. Where the CAS instruction is executed successfully (YES in S15), the updated lock variable is substituted to the lock variable AQ_LOCK at the time of lock acquisition (S20).

[Summary of Lock Release Processing]

In the lock release processing illustrated by FIG. 10, the exclusive control device reads the lock variable LOCK_VAL from the lock variable storage device and substitutes the lock variable to the old value (S31). Then, where the old value which is the read lock variable is equal to the lock variable AQ_LOCK at the time of lock acquisition (old value=AQ_LOCK, YES in S32), the exclusive control device substitutes the new lock variable in which the lock state flag has been changed to the lock release state and the lock identification information of the old value has been updated (LOCK_FLG=0, LOCK_ID=time-out) to the new value (S33) and executes the CAS instruction (S34). Where the lock has been acquired by the exclusive control device performing the lock release processing, since the old value=lock variable, the CAS instruction is successful (YES in S35). In the case of the lock acquired by another exclusive control device, since the lock identification information of the lock variable storage device does not match the old value (old value is≈lock variable) lock identification information of the lock variable at the time of lock acquisition, the CAS instruction fails (NO in S35, S36).

When the lock identification information (AQ_LOCK) of the lock variable at the time the exclusive control device, which is to perform the lock release processing, has itself acquired the lock, and the lock identification information of the present lock variable do not match (S32 is NO), the lock was acquired by the other exclusive control device. Therefore, the lock release processing is not able to be performed. The lock release processing is performed only when the two types of information match (S32 is YES).

Examples of various types of exclusive control processing in the present embodiment will be described hereinbelow. The five examples hereinbelow are described with reference to the processing numbers in FIGS. 6 to 10.

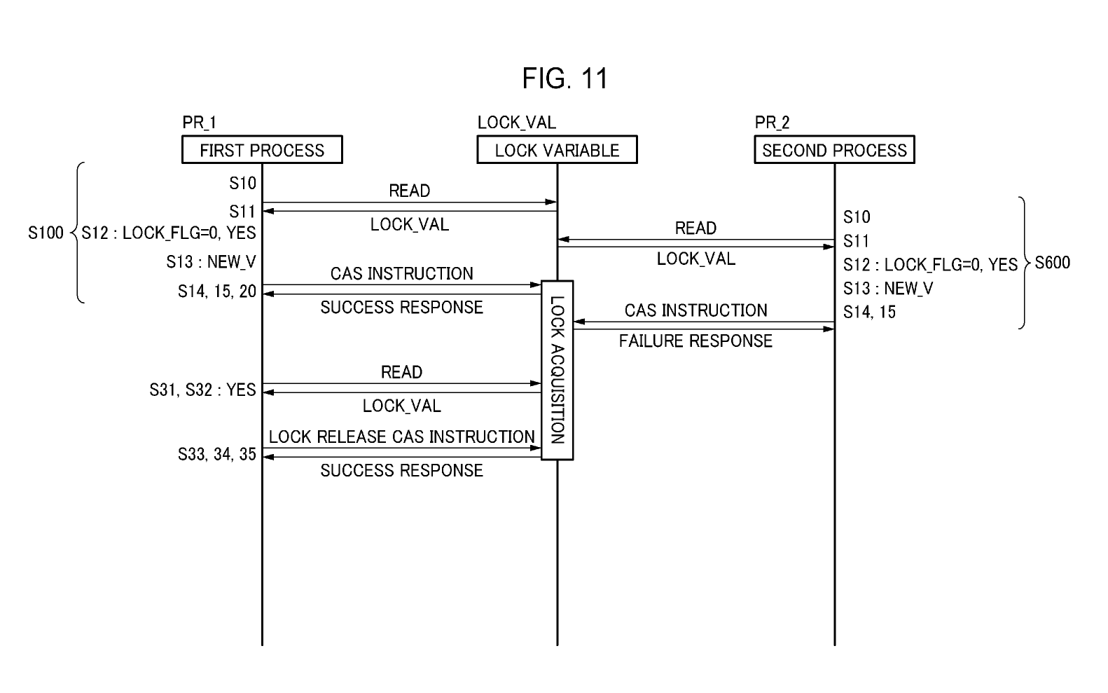

### EXAMPLE 1 IN WHICH THE LOCK ACQUISITIONS OF THE FIRST AND SECOND PROCESSES COMPETE (FIG. 11)

FIG. 11 is a sequence diagram of Example 1 in which the lock acquisitions of the first and second processes compete. In Example 1, when the lack state flag is the lock release state, the lock acquisitions of the first process PR_1 and second process PR_2 compete. As depicted in FIG. 11, the first process PR_1 starts the lock acquisition processing (FIG. 6) earlier. In other words, the exclusive control device of the first process executes the first processing (S100: S10, S11, S12, S13, S14, S15, and S20) and acquires a lock. Thus, the exclusive control device performs the initialization processing S10, lock variable read S11, detection that the lock state flag LOCK_FLG is LOCK_FLG=0 (YES in S12), and CAS instruction (S13, S14) that swaps the lock variable to the new value NEW_V (LOCK_FLG=1, LOCK_ID=time stamp). With the success of CAS instruction, a lock is acquired. The lock variable which has been swapped by the CAS instruction is then stored as the lock variable AQ_LOCK at the time of lock acquisition (S20).

Meanwhile, the second process starts the lock acquisition processing almost at the same time, but somewhat later. In other words, the exclusive control device of the second process executes the sixth processing (S600: S10, S11, S12: YES, S13, S14, S15: NO) of lock acquisition failure. Since the lock state flag is during the lock release (S12: YES), the exclusive control device executes the CAS instruction (S14), but since the first process has performed the lock acquisition earlier, the old value and lock variable do not match, the CAS instruction fails, and the lock acquisition is not performed.

Since the CAS instruction of the first process is processed atomically, the CAS instruction of the first process is successful, and the CAS instruction of the second process, which is executed after the completion of the CAS instruction of the first process, fails.

In Example 1, the lock state flag is used and the CAS instruction is executed. Therefore, although the lock acquisitions of the first and second processes compete, only the first process, which is to acquire a lock earlier, can acquire the lock and adequately perform the exclusive control.

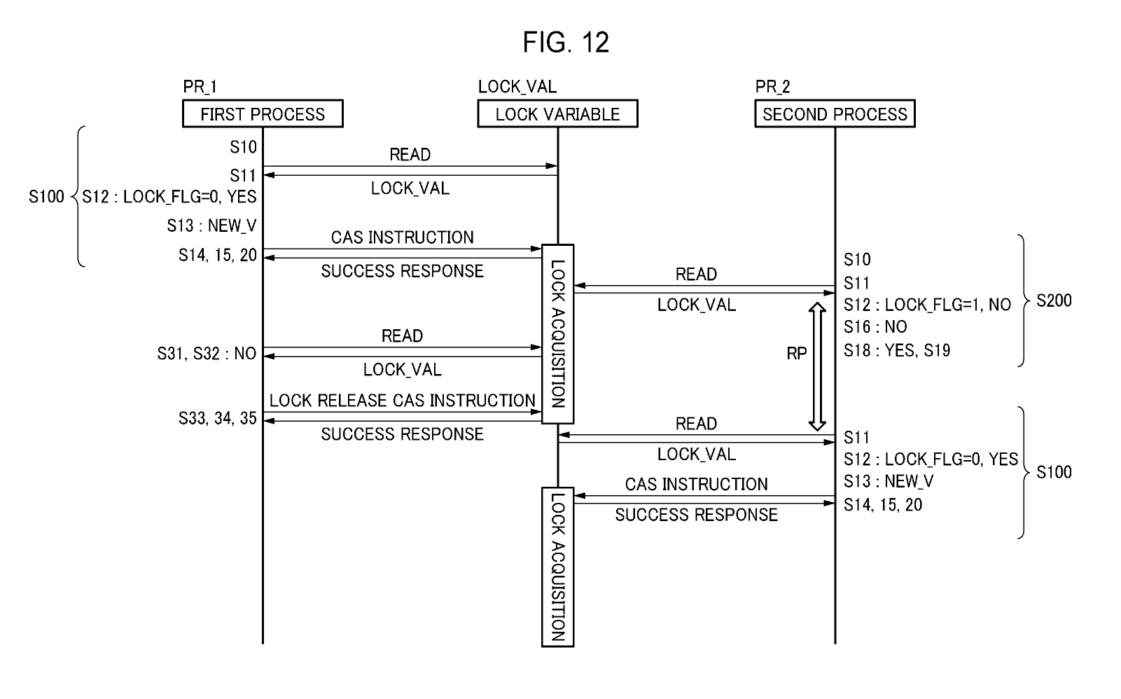

### EXAMPLE 2 IN WHICH THE SECOND PROCESS PERFORMS THE LOCK ACQUISITION AFTER THE LOCK ACQUISITION BY THE FIRST PROCESS (FIG. 12)

FIG. 12 is a sequence diagram of Example 2 in which the second process performs the lock acquisition after the lock acquisition by the first process. In Example 2, as the first process performs the lock acquisition processing and acquires the lock, the second process attempts the lock acquisition during the lock acquisition by the first process, but fails due to the lock acquisition state, and the second process performs the lock acquisition again after the first process has performed the lock release processing.

In FIG. 12, initially, the first process PR_1 starts the lock acquisition processing (FIG. 6), and the exclusive control device of the first process executes the first processing (S100: S10, S11, S12, S13, S14, S15, and S20) and acquires the lock. Then, the lock variable which has been written (swapped) to the lock variable at the time of lock acquisition is stored as the lock variable AQ_LOCK at the time of lock acquisition (S20).

Then, the exclusive control device of the second process executes the second processing (S200). Thus, the exclusive control device of the second process, attempts the lock acquisition processing during the lock acquisition by the first process (S10, S11, S12) However, since the lock state flag is during the lock acquisition (LOCK_FLG=1) (NO in S12), NO is obtained in the time-out determination step S16, YES is obtained in the initial time determination step S18 after the new lock acquisition, and the exclusive control device executes the time-out start processing S19.

Then, the exclusive control device of the first process performs the lock release processing (S31, YES in S32, S33, S34, YES in S35). The exclusive control device reads the lock variable and substitutes it to the old value (S31), and since the exclusive control device is in the lock acquisition state in which the present lock has been acquired by the device itself, the condition of old value=AQ_LOCK is realized in the processing step S32 (YES in S32), and the CAS instruction for the lock release (S34) is successful (YES in S35).

After the lock release, where the exclusive control device of the second process reads the lock variable again after the retry period RP elapses (S11), because the lock release state is realized this time (LOCK_FLG=0, YES in S12), the processing steps S13, S14, S15, and S20 are executed, and the lock is acquired. This processing is the same as the first processing S100.

In Example 2, as a result of storing the lock variable AQ_LOCK at the time of lock acquisition, the exclusive control device can perform the lock release processing only with respect to the lock which has been acquired by the device itself, and the lock release processing is not able to be performed with respect to the locks acquired by other exclusive control devices. In the present embodiment, since the lock acquisition is forcibly enabled at the time of time-out detection, the above lock release processing including S32 is effective

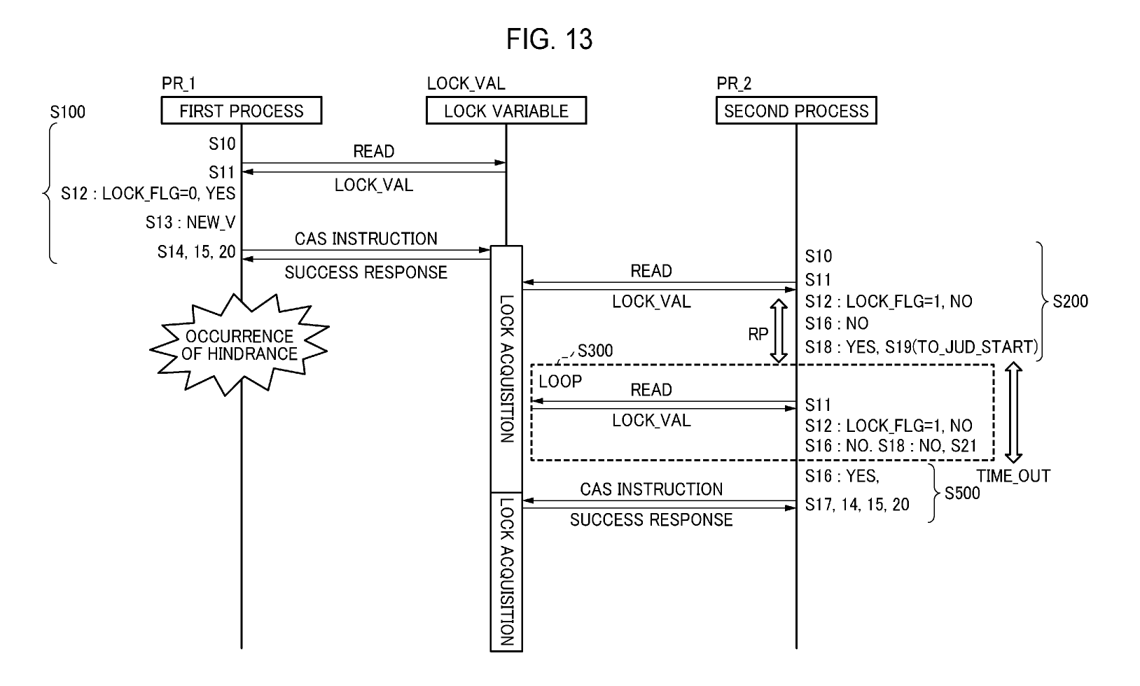

### EXAMPLE 3 IN WHICH THE SECOND PROCESS ACQUIRES THE LOCK AT A TIME-OUT DURING THE LOCK ACQUISITION BY THE FIRST PROCESS (FIG. 13)

FIG. 13 is a sequence diagram of Example 3 in which a time-out occurs during the lock acquisition by the first process and therefore the second process performs lock acquisition. Thus, in this example, after the first process has performed the lock acquisition, the lock release becomes impossible due to the occurrence of a hindrance, or the like, the second process detects the time-out of the lock and acquires the lock appropriately.

In FIG. 13, initially, the first process PR_1 starts the lock acquisition processing (FIG. 6), and the exclusive control device executes the first processing (S10, S11, S12, S13, S14, S15, S20) and acquires the lock. Then, the lock variable which has been written (swapped) to the lock variable at the time of lock acquisition is stored as the lock variable AQ_LOCK at the time of lock acquisition (S20).

The exclusive control device of the second process then executes the second processing (S200: S11, S12, S16, S18, S19, and S21). Thus, the exclusive control device attempts the lock acquisition processing during the lock acquisition by the first process (S10, S11, S12). However, since the lock state flag is during the lock acquisition (LOCK_FLG=1) (NO in S12), NO is obtained in the time-out determination step S16, YES is obtained in the initial time determination step S18 after the new lock acquisition, and the exclusive control device executes the time-out start processing S19. The time-out determination by the exclusive control device of the second process is started at this point of time. Up to this time, the procedure is the same as in Example 2 depicted in 12.

Thus, the exclusive control device of the second process performs the third processing (S300: S11, S12, NO in S16, NO in S18, S21) of repeating the time-out determination in the lock acquisition state depicted in FIG. 6. The third processing is repeated up to a time-out in the same lock state (YES in S16).

Before long, the exclusive control device of the second process detects the time-out in the same lock state (YES in S16) and performs the lock acquisition. This processing is the fifth processing (S500: S11, S12, S16: YES, S17, S14, S15: YES, S20) in which a time-out is detected and the lock is acquired in the lock acquisition state depicted in FIG. 6.

In Example 3, as a result of confirming that the lock identification information LOCK_ID of the lock variable matches the lock identification information of the lock variable S_LOCK at the time of time-out determination start (YES in S51 of S16), the exclusive control device can determine that the time-out took place in the same lock.

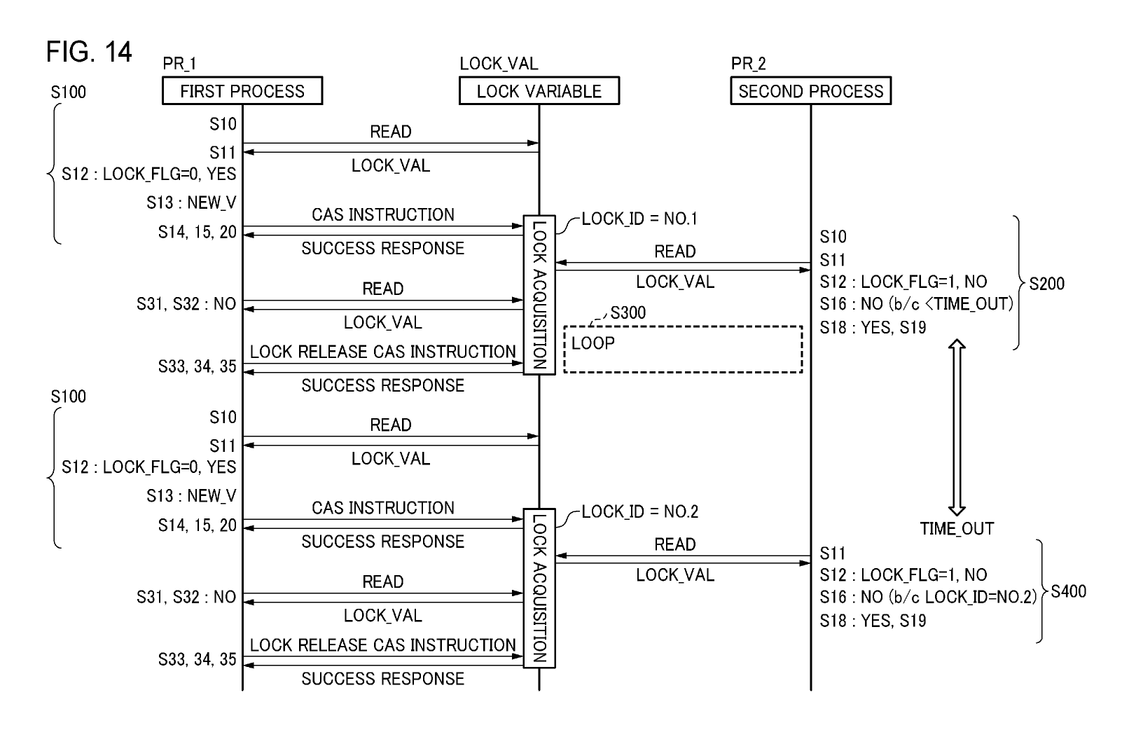

### EXAMPLE 4 OF TIME-OUT DETERMINATION WHEN THE FIRST PROCESS REPEATS THE LOCK ACQUISITION AND RELEASE (FIG. 14)

FIG. 14 is a sequence diagram of Example 4 in which, when the first process repeats the lock acquisition and release, the second process is not able to detect the time-out in the same lock so that the situation in which the two processes acquire together the lock can be avoided. In Example 4, the problem illustrated by FIG. 3 is avoided.

In FIG. 14, the exclusive control device of the first process PR_1 executes the first processing (S100: S10, S11, S12: YES, S13, S14, S15: YES, S20) which is the lock acquisition processing. As a result, the exclusive control device of the first process acquires the lock with the lock identification information LOCK_ID=NO. 1.

After the first process has acquired the lock, the exclusive control device of the second process PR_2 executes the second processing (S200: S10, S11, S12: NO, S16: NO, S18: YES, S19) in an attempt to perform the lock acquisition processing. Because of the lock acquisition state, the exclusive control device is not able to acquire the lock, and performs the time-out determination start processing S19 and stores, as an internal variable, the lock identification information LOCK_ID=NO. 1 as the lock variable S_LOCK at the time of determination start.

Further, in the lock acquisition state by the first process, the exclusive control device of the second process repeats the third processing S300 having the lock determination processing. In this example, it is assumed that a time-out does not occur without reaching the time-out elapse time in the lock determination processing S16 in the third processing S300.

Then, the exclusive control device of the first process executes the lock release processing (S31, S32, S33, S34, S35), and immediately thereafter, the exclusive control device of the first process executes the lock acquisition processing S100, and again acquires the lock anew. The lock identification information LOCK_ID of the acquired lock is LOCK_ID=NO. 2.

Meanwhile, in the lock acquisition state by the first process, the exclusive control device of the second process executes the fourth processing S400 (S11, S12: NO, S16; NO, S18: YES, S19) including the lock determination processing. In other words, in the time-out determination S16 of the fourth processing S400 which is performed by the exclusive control device, the determination is NO because although the time-out time has elapsed since the determination start timing, the lock identification information LOCK_ID (NO. 1) at the time of determination start, i.e. S_LOCK, does not match the lock identification information LOCK_ID (NO. 2) of the present lock variable (NO. 1≈NO. 2). Thus, it is not possible to determine that a time-out has occurred. Further, the determination S18 of the first time in the new lock becomes YES and the time-out determination start processing S19 is executed.

In the example depicted in FIG. 3, because the time-out has been determined on the basis of whether the time-out time has elapsed since the initial lock acquisition state, without distinguishing among the individual lock acquisition states, the second process has erroneously acquired the lock. However, in Example 4 of the present embodiment, which is depicted in FIG. 14, the exclusive control device stores, at the time of time-out determination start, the lock identification information LOCK_ID of the lock variable in the lock variable S_LOCK at the time of determination start, among the internal variables (S19), and determines whether or not the present lock identification information LOCK_ID matches the lock identification information LOCK_ID of the lock variable S_LOCK at the time of determination start in the subsequent time-out determination S16. As a result, the exclusive control device determines whether or not the same lock acquisition state has been maintained. Therefore, the exclusive control device can negate the time-out determination when a lock has been changed to a different lock, even though the time-out time has elapsed since initially determining the lock acquisition state. The situation in which the second process erroneously acquires the lock is thus avoided.

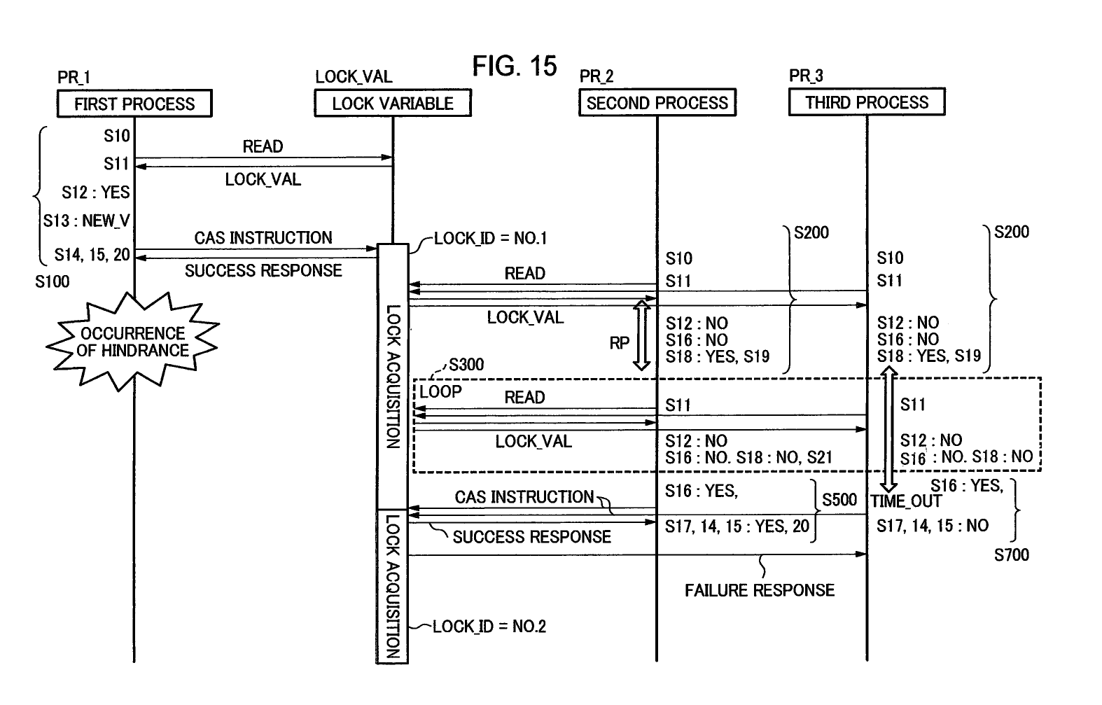

### EXAMPLE 5 IN WHICH THE LOCK ACQUISITIONS OF THE SECOND AND THIRD PROCESSES COMPETE DURING THE LOCK ACQUISITION BY THE FIRST PROCESS (FIG. 15)

FIG. 15 is a sequence diagram of Example 5 in which the second and third processes detect a time-out during the lock acquisition by the first process and the lock acquisitions compete between them. In FIG. 15, the first process cannot perform the lock release due to the occurrence of a hindrance, or the like, after the lock acquisition by the first process. The second and third processes detect a time-out almost simultaneously and execute the forced lock acquisition. However, since the CAS instruction S14 at the time of forced lock acquisition is an atomic instruction, the CAS instruction of the second process is successful, and the CAS instruction of the third process fails. In Example 5, the problem illustrated by FIG. 4 is avoided.

In FIG. 15, the exclusive control device of the first process executes the first processing S100 and acquires the lock. After this acquisition, the first process is not able to release the lock due to a hindrance, or the like.

In the lock acquisition state produced by the first process, the second and third processes execute the second processing S200 to start the time-out determination, and also repeat the third processing S300 including the time-out determination.

While the lock by the first process (lock identification information LOCK_ID=NO. 1) is maintained, the second and third processes determine in the time-out determination S16 that the time-out has elapsed in the same lock (S16: YES) and attempt the respective forced lock acquisition processing. In this case, the execution of the CAS instruction by the exclusive control device of the second process is started earlier, and the execution of the CAS instruction by the third process is started with a delay. As a result, the CAS instruction by the exclusive control device of the second process is successful (S15: YES). As a consequence, the lock identification information LOCK_ID of the lock variable is updated and has become LOCK_ID=NO. 2. In other words, the exclusive control device of the second process can execute the fifth processing S500.

Meanwhile, since the old value is LOCK_ID=NO. 1 and the lock identification information LOCK_ID=NO. 2 of the lock variable, the two do not match, and the CAS instruction by the exclusive control device of the third process fails (S15: NO). In other words, the exclusive control device of the third process executes the seventh processing S700.

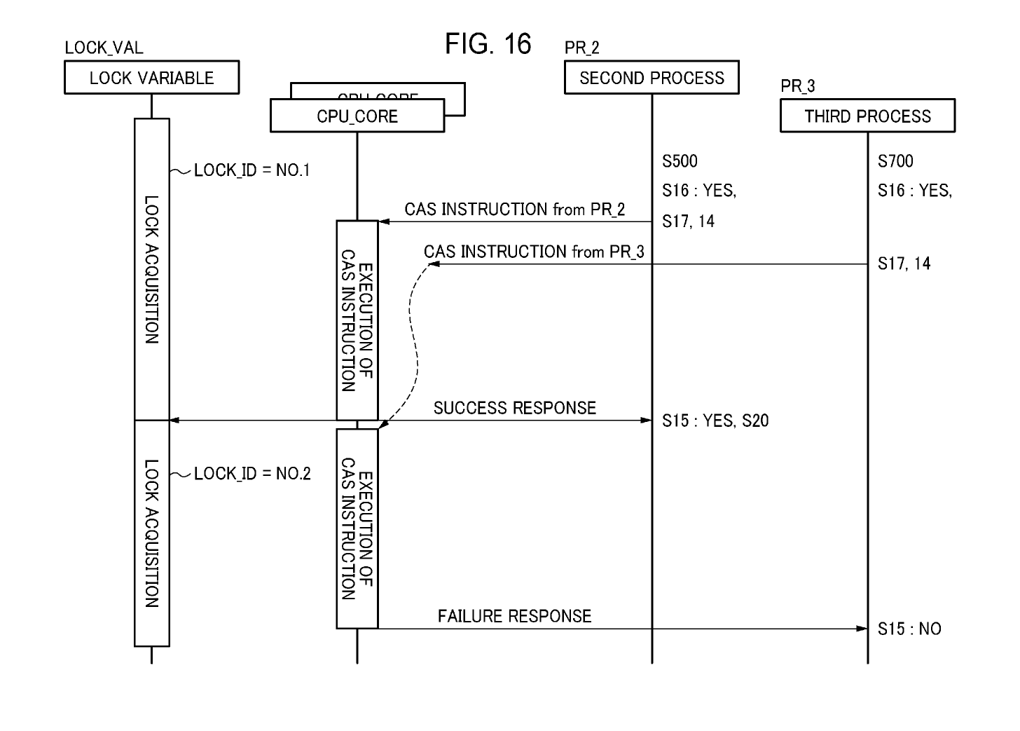

FIG. 16 is a sequence diagram of the CAS instruction performed by the second process and the CAS instruction performed by the third process in FIG. 15. The second process executes the fifth processing S500, and the third process executes the seventh processing S700.

Initially, the exclusive control device of the second process PR_2 detects the time-out (S16: YES) and executes the CAS instruction that takes as the old value the lock variable (lock identification information LOCK_ID=NO. 1) which has been read immediately therebefore (S11) and takes as the new value the updated lock variable (lock identification information LOCK_ID=NO. 2) (S17, S14). In this CAS instruction, since the old value and the lock variable (lock identification information LOCK_ID=NO. 1) in the lock variable storage device match, the new value is written to the lock variable and the CAS instruction is successful (S15: YES). As a result, the lock identification information LOCK_ID of the lock variable in the lock variable storage device is updated to NO. 2.

Meanwhile, the exclusive control device of the third process PR_3 also detects a time-out (S16: YES) and executes the CAS instruction that takes as the old value the lock variable (LOCK identification information LOCK_ID=NO. 1) which has been read immediately therebefore (S11) and takes as the new value the updated lock variable (lock identification information LOCK_ID=NO. 2) (S17, S14). However, the CPU core executes atomically the CAS instruction of the second process first, and the CAS instruction of the third process is kept waiting. The CPU core executes the CAS instruction of the third process after the CAS instruction of the second process is completed. However, at this time, the lock identification information LOCK_ID of the lock variable has already been updated to became LOCK_ID=NO. 2. Therefore, in the CAS instruction of the third process, the old value (LOCK_ID=NO. 1) and the current lock variable (LOCK_ID=NO. 2) do not match and the instruction ends as a failure.

In the above-described Example 5, since the lock variable LOCK_VAL also has the lock identification information LOCK_ID, even when the second and third processes detect a time-out at the same time, the CAS instruction is successful and the lock is acquired only in the second process, which has started the CAS instruction earlier, whereas the CAS instruction fails in the third process, which has started the CAS instruction later. As a result, the situation in which the second and third processes depicted in FIG. 4 together acquire the lock is avoided.

[Information Processing Device, Information Processing System]

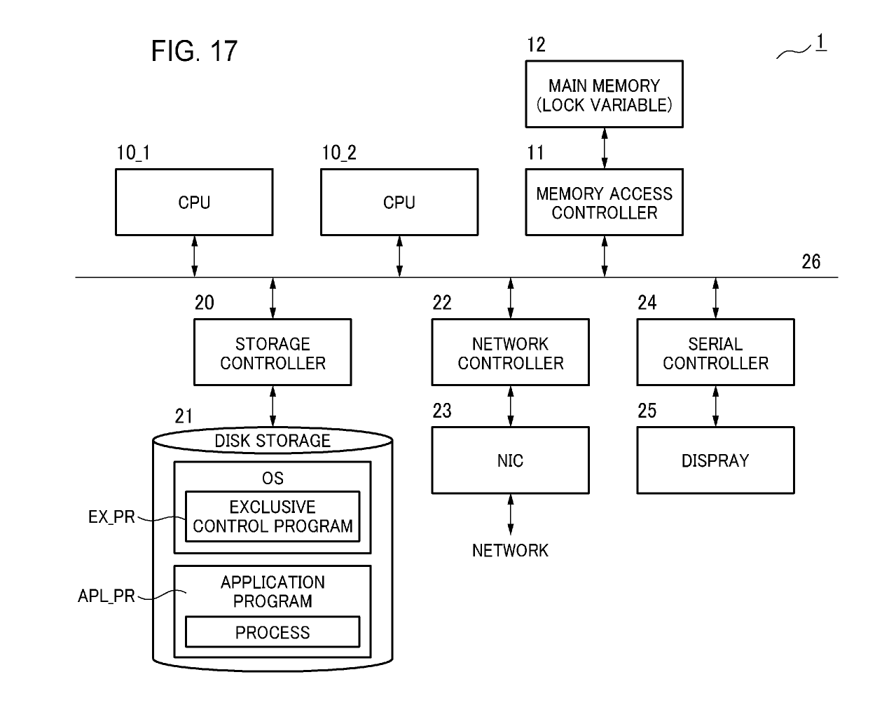

FIG. 17 illustrates the configuration of an information processing device in the present embodiment. The information processing device 1 depicted in FIG. 17 has a plurality of CPUs 10_1, 10_2, a main memory 12 connected through a memory access controller 11, a large-capacity disk storage 21 connected through a storage controller 20, a network interface card 23 connected through a network controller 22, a display device 25 connected through a serial controller 24, and a bus 26 connecting those components.

Lock variables are stored in the main memory 12. Therefore, the main memory 12 corresponds to the lock variable storage device. The disk storage 21 stores an operation system OS and an application program APL_PR. Those are expanded in the main memory 12 and executed by the CPU.

The OS has an exclusive control program EX_PR. The application program APL_PR is split into a plurality of processes which are executed in parallel by the same CPU or different CPUs. When each CPU has a plurality of CPU cores, the same CPU cores or different CPU cores in the same CPU or different CPUs execute the plurality of processes in parallel.

A data storage region in the main memory 12 or disk storage 21 in the information processing device 1 corresponds to the common resource in the present embodiment. The CPUs or CPU cores executing in parallel the plurality of processes execute the access to the common resource exclusively from each other through the exclusive control program.

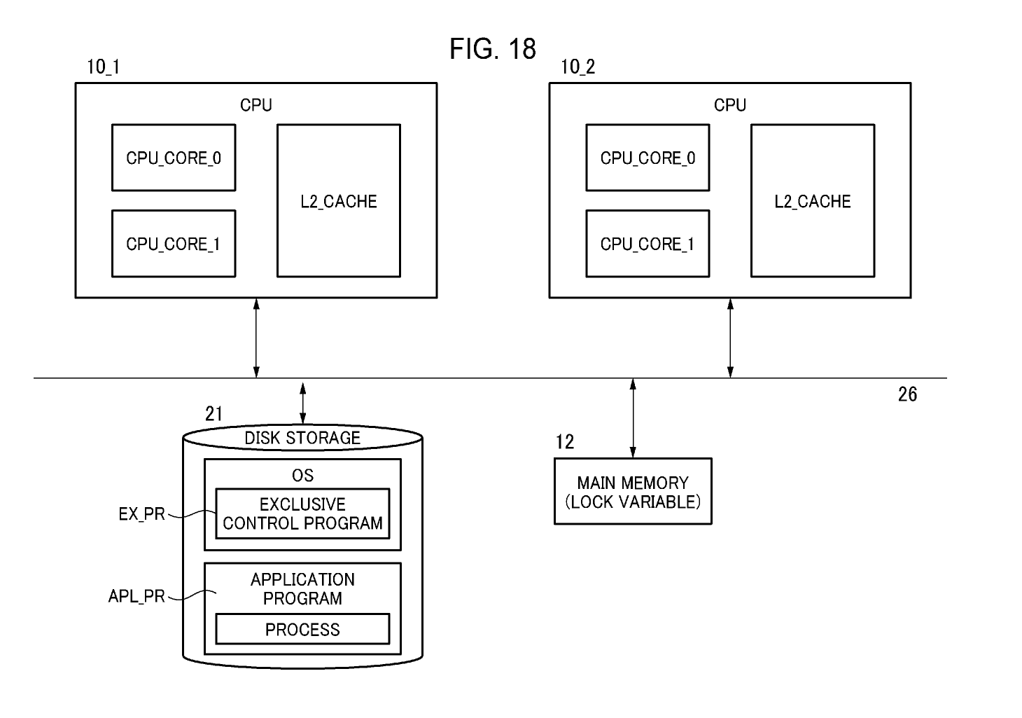

FIG. 18 illustrates the configuration including two CPUs and disk storages depicted in FIG. 17. The two CPUs 10_1, 10_2 each have two CPU cores CPU_CORE_0, CPU_CORE_1 and a secondary cache L2_CACHE. The same or different CPU cores execute in parallel the plurality of processes in the application program APL_PR. When the plurality of processes accesses the common resource to write data, the exclusive control program of the OS is called and the CPU cores executing the processes execute the called exclusive control program.

In the above-described case, the process execution unit and exclusive control device correspond to the CPU core in the CPU.

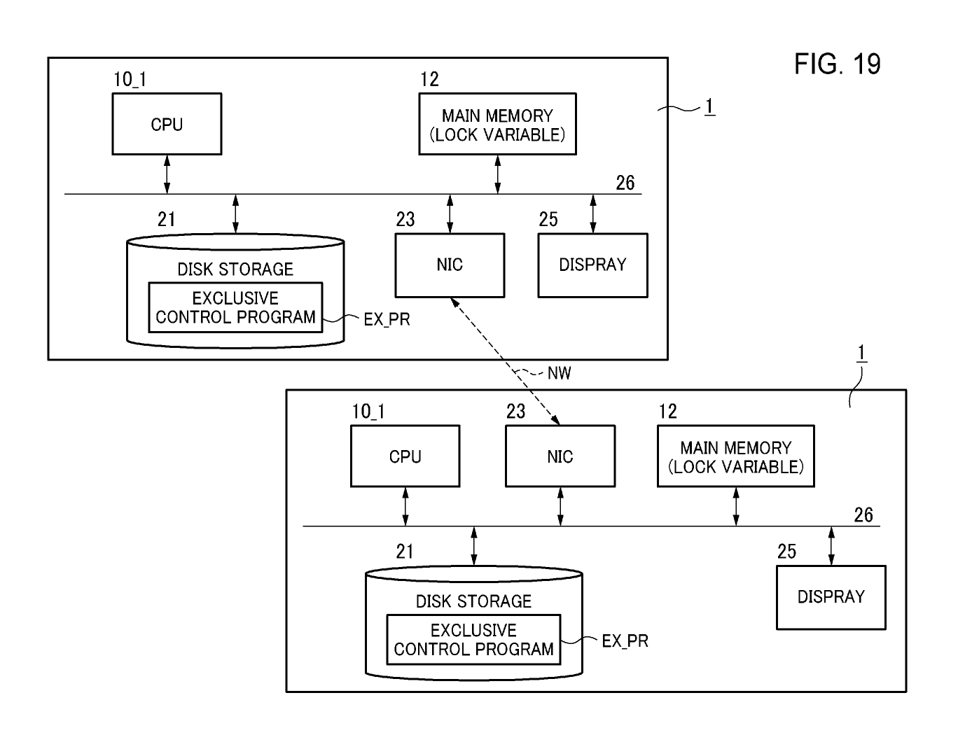

FIG. 19 illustrates the configuration of the information processing system in the present embodiment. In the information processing system depicted in FIG. 19, two information processing devices 1 are connected via a network NW. Each information processing device 1 is the same as the information processing device depicted in FIGS. 17 and 18.

In the information processing system, for example, an area that stores the common data in the main memory 12 in one information processing device 1 corresponds to the common resource. In some cases, the CPUs or CPU cores in the two information processing devices execute the plurality of processes in parallel and access the common resource in the main memory 12 in one information processing device. In other cases, the CPUs or CPU cores in one information processing device execute the plurality of processes in parallel and access the common resource in the main memory 12 in the other information processing device.

With any configuration, the CPU or CPU core executing a plurality of processes corresponds to the process execution unit. Further, the area of the common variable in the main memory corresponds to the common resource. When the process execution unit accesses the common resource and changes data, the exclusive control program in the OS is called and executed and exclusive control between the processes is performed.

As indicated hereinabove, in the present embodiment, the exclusive control with respect to the common resource between a plurality of processes executed in parallel can be adequately performed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a plurality of process execution units that execute respective processes;
a lock variable storage device that stores, with respect to a lock relating to a common resource which is accessed by the plurality of process execution units, a lock variable having a lock state flag indicating a lock acquisition state and a lock release state, and a lock identification information which is updated each time the lock is acquired; and
an exclusive control device that executes
first lock acquisition processing, which includes, when the lock state flag is the lock release state, updating the lock state flag of the lock variable in the lock variable storage device to the lock acquisition state, and updating the lock identification information of the lock variable to newly updated lock identification information, to acquire the lock for the process execution unit, and
second lock acquisition processing, which includes, when the lock state flag is the lock acquisition state, updating the lock identification information of the lock variable in the lock variable storage device to newly updated lock identification information to acquire the lock for the process execution unit, after a predetermined time-out time elapses while the lock variable in the lock variable storage device maintains the same lock identification information.

2. The information processing device according to claim 1, wherein
in the first lock acquisition processing, the exclusive control device:
reads the lock variable at a predetermined timing and sets the read-out variable to an old value;
when the lock state flag of the old value is the lock release state, sets a lock variable, in which the lock state flag is the lock acquisition state and the lock identification information is the newly updated lock identification information, to a new value; and
executes, with an atomic instruction, compare-and-swap processing of comparing the old value and the lock variable in the lock variable storage device and swapping the lock variable in the lock variable storage device to the new value, provided that the result of the comparing is matched.

3. The information processing device according to claim 1, wherein
in the second lock acquisition processing, the exclusive control device:
at a first timing, when the lock state flag of the lock variable which has been read from the lock variable storage device is the lock acquisition state, starts time-out determination as to whether or not a predetermined time-out time has elapsed, while the lock variable in the lock variable storage device maintains the same lock identification information; and
at a second timing after the first timing, updates the lock identification information of the lock variable to the newly updated lock identification information when the time-out time has elapsed and when the lock identification information of the lock variable read from the lock variable storage device at the second timing is the same as the lock identification information read at the first timing.

4. The information processing device according to claim 3, wherein
in the processing of updating the lock identification information of the lock variable to the newly updated lock identification information in the second lock acquisition processing, the exclusive control device:
sets the lock variable which has been read at the second timing to the old value;
sets a lock variable, in which the lock state flag is the lock acquisition state and the lock identification information is the newly updated lock identification information, to a new value; and
executes, with an atomic instruction, compare-and-swap processing of comparing the old value and the lock variable in the lock variable storage device and swapping the lock variable in the lock variable storage device to the new value is executed with an atomic instruction, provided that the result of the comparing is matched.

5. The information processing device according to claim 1, wherein
the exclusive control device reads the lock variable from the lock variable storage device and, when the read-out lock variable matches a lock variable which has been updated at the time the lock has been acquired, executes lock release processing of updating the lock state flag of the lock variable in the lock variable storage device to the lock release state.

6. The information processing device according to claim 5, wherein
in the lock release processing, the exclusive control device:
sets the lock variable read from the lock variable storage device to n old value,
sets a lock variable in which the lock state flag is the lock release state to a new value, and
executes, with an atomic instruction, compare-and-swap processing of comparing the old value and the lock variable in the lock variable storage device and swapping the lock variable in the lock variable storage device to the new value, provided that the result of the comparing is matched.

7. An information processing system comprising:
a plurality of process execution units that execute respective processes;
a common resource which is accessed by the plurality of process execution units;
a lock variable storage device that stores, with respect to a lock relating to the common resource, a lock variable having a lock state flag indicating a lock acquisition state and a lock release state, and a lock identification information which is updated each time the lock is acquired; and
an exclusive control device that executes
first lock acquisition processing, which includes, when the lock state flag is the lock release state, updating the lock state flag of the lock variable in the lock variable storage device to the lock acquisition state, and updating the lock identification information of the lock variable to newly updated lock identification information, to acquire the lock for the process execution unit, and
second lock acquisition processing, which includes, when the lock state flag is the lock acquisition state, updating the lock identification information of the lock variable in the lock variable storage device to newly updated lock identification information to acquire the lock for the process execution unit, after a predetermined time-out time elapses while the lock variable in the lock variable storage device maintains the same lock identification information.

8. A non-transitory computer-readable storage medium storing therein an exclusive control program for causing a computer to execute a process comprising:
accessing a lock variable storage device that stores, with respect to a lock relating to a common resource which is accessed by a plurality of process execution units, each of which executes respective process, a lock variable having a lock state flag indicating a lock acquisition state and a lock release state, and a lock identification information which is updated each time the lock is acquired;
executing first lock acquisition processing, which includes, when the lock state flag is the lock release state, updating the lock state flag of the lock variable in the lock variable storage device to the lock acquisition state, and updating the lock identification information of the lock variable to newly updated lock identification information, to acquire the lock for the process execution unit, and
executing second lock acquisition processing, which includes, when the lock state flag is the lock acquisition state, updating the lock identification information of the lock variable in the lock variable storage device to newly updated lock identification information to acquire the lock for the process execution unit, after a predetermined time-out time elapses while the lock variable in the lock variable storage device maintains the same lock identification information.

9. The non-transitory computer-readable storage medium according to claim 8, wherein
in the first lock acquisition processing,
reading the lock variable at a predetermined timing and sets the read-out variable to an old value;
when the lock state flag of the old value is the lock release state, setting a lock variable, in which the lock state flag is the lock acquisition state and the lock identification information is the newly updated lock identification information, to a new value; and
executing, with an atomic instruction, compare-and-swap processing of comparing the old value and the lock variable in the lock variable storage device and swapping the lock variable in the lock variable storage device to the new value, provided that the result of the comparing is matched.

10. The non-transitory computer-readable storage medium according to claim 8, wherein
in the second lock acquisition processing, the exclusive control device:
at a first timing, when the lock state flag of the lock variable which has been read from the lock variable storage device is the lock acquisition state, starting time-out determination as to whether or not a predetermined time-out time has elapsed, while the lock variable in the lock variable storage device maintains the same lock identification information; and
at a second timing after the first timing, updating the lock identification information of the lock variable to the newly updated lock identification information when the time-out time has elapsed and when the lock identification information of the lock variable read from the lock variable storage device at the second timing is the same as the lock identification information read at the first timing.

11. The non-transitory computer-readable storage medium according to claim 10, wherein
in the processing of updating the lock identification information of the lock variable to the newly updated lock identification information in the second lock acquisition processing,
setting the lock variable which has been read at the second timing to the old value,
setting a lock variable, in which the lock state flag is the lock acquisition state and the lock identification information is the newly updated lock identification information, to a new value, and
executing, with an atomic instruction, compare-and-swap processing of comparing the old value and the lock variable in the lock variable storage device and swapping the lock variable in the lock variable storage device to the new value is executed with an atomic instruction, provided that the result of the comparing is matched.

12. The non-transitory computer-readable storage medium according to claim 8, the process further comprising:
reading the lock variable from the lock variable storage device and,
when the read-out lock variable matches a lock variable which has been updated at the time the lock has been acquired, executing lock release processing of updating the lock state flag of the lock variable in the lock variable storage device to the lock release state.
